(19) United States
(12) Patent Application Publication
(10) Pub. No.: US 2021/0250240 A1
(43) Pub. Date: Aug. 12, 2021

(54) CONFIGURATION SETTING SUPPORT SYSTEM AND METHOD

(71) Applicant: Hitachi, Ltd., Tokyo (JP)

(72) Inventor: Yuta OHTSU, Tokyo (JP)

(21) Appl. No.: 17/022,196

(22) Filed: Sep. 16, 2020

(30) Foreign Application Priority Data
Feb. 6, 2020 (JP) 2020-018777

(51) Int. Cl. H04L 12/24

(52) U.S. Cl. CPC H04L 41/0879; H04L 41/0806; H04L 41/0853

(57) ABSTRACT

A configuration setting support system that supports setting of configuration information in an information processing apparatus includes: an information acquirer configured to acquire configuration information set in a plurality of information processing apparatuses under management; and a candidate extractor configured to select at least one of the plurality of information processing apparatuses under management on the basis of a configuration of a target information processing apparatus and the configuration information of the plurality of information processing apparatuses under management and uses the selected at least one information processing apparatus under management as a recommended candidate recommended to be used for creating the configuration information of the target information processing apparatus.

### CROSS-REFERENCE TO RELATED APPLICATIONS

This application is based upon and claims the benefit of priority from Japanese Patent Application No. 2020-018777 filed in Japan Patent Office on Feb. 6, 2020, the contents of which are hereby incorporated by reference.

### BACKGROUND

The present disclosure relates to a technique of supporting setting the configuration of an information processing system.

Japanese Patent Application Publication No. 2010-282486 discloses a management computer which enables a system administrator to efficiently perform operations associated with construction of an information processing system.

The management computer disclosed in Japanese Patent Application Publication No. 2010-282486 includes a statistic information analyzer that acquires environment information of components of resources of the information processing system serving as a management target, an automation incompatibility calculator that generates history information of processing of the system administrator constructing the environment of the resources and applies weighting to automated processing and manual processing on the resources, and a script creator that controls construction of the environment of the resources.

The automation incompatibility calculator applies weighting to processing requested from the system administrator on the basis of the history information and controls automated and manual processing by digging down from a processing target device and resource to the parameters constituting the device and resource.

### SUMMARY

In recent years, an information processing system such as a storage system has been sophisticated, and initial settings at the time of initial introduction and setting changes at the time of changing the configuration have become complex. Although the use of the management computer of Japanese Patent Application Publication No. 2010-282486 makes the operation of a system administrator made efficient, manual processing involves many complex operations. The workload of the system administrator may be alleviated if appropriate configuration settings are suggested.

An object of the present disclosure is to provide a technique which enables appropriate configuration settings of an information processing system to be suggested.

A configuration setting support system according to an aspect of the present disclosure is a configuration setting support system that supports setting of configuration information in an information processing apparatus, the configuration setting support system including: an information acquirer configured to acquire configuration information set in a plurality of information processing apparatuses under management; and a candidate extractor configured to select at least one of the plurality of information processing apparatuses under management on a basis of a configuration of a target information processing apparatus and the configuration information of the plurality of information processing apparatuses under management and uses the selected at least one information processing apparatus under management as a recommended candidate recommended to be used for creating the configuration information of the target information processing apparatus.

According to an aspect of the present disclosure, since the recommended candidate is selected from information processing apparatuses under management, it is possible to support setting of configuration information in the target information processing apparatus on the basis of the configuration information having records.

### BRIEF DESCRIPTION OF THE DRAWINGS

FIG. 1 is a block diagram of an entire system including a storage system and a configuration setting support system;

FIG. 2 is a diagram illustrating an example of configuration information;

FIG. 3 is a diagram illustrating an example of an operation log;

FIG. 4 is a diagram illustrating an example of analysis data;

FIG. 5 is a flowchart of merging processing;

FIG. 6 is a flowchart of recommended candidate selection processing;

FIG. 7 is a flowchart of recommended candidate selection processing;

FIG. 8 is a flowchart of recommended candidate selection processing;

FIG. 9 is a conceptual diagram for describing processing step A2;

FIG. 10 is a conceptual diagram for describing processing step A6;

FIG. 11 is a flowchart of script creation processing;

FIG. 12 is a sequence diagram between apparatuses associated with the merging process;

FIG. 13 is a sequence diagram between apparatuses associated with the recommended candidate selection process and the script creation process;

FIG. 14 is a diagram illustrating an input screen for receiving the user's input of a script creation instruction; and

FIG. 15 is a diagram illustrating an output screen for presenting a recommended candidate to a user.

### DETAILED DESCRIPTION OF THE EMBODIMENT

Hereinafter, an embodiment will be described with reference to the drawings.

In the present embodiment, a storage apparatus is the target in which the configuration information is set, and a configuration setting support system that supports setting of the configuration information in the storage apparatus is illustrated. The configuration setting support system places a plurality of storage apparatuses under management and can acquire the configuration information and the operation log from the storage apparatuses. The configuration setting support system selects a recommended candidate on the basis of the information acquired from the storage apparatuses under control and generates scripts which are the support information for setting the configuration information in a target storage apparatus on the basis of the configuration information of the recommended candidate. Although the target in which the configuration information is set is a storage apparatus in this example, there is no limitation thereto. The target in which the configuration information is set may be an information processing apparatus other than the storage apparatus. Moreover, the target information processing apparatus may be a physical information processing apparatus and may be a virtual information processing apparatus.

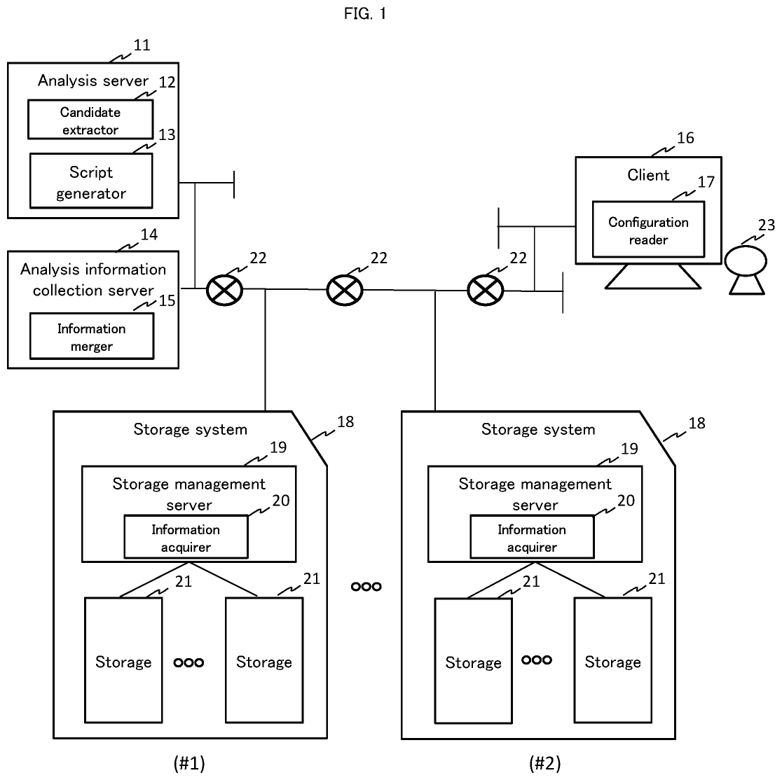

FIG. 1 is a block diagram of an entire system including a storage system and a configuration setting support system.

Referring to FIG. 1, the entire system includes an analysis server 11, an analysis information collection server 14, a client 16, and a plurality of storage systems 18. The configuration of the configuration setting support system is not particularly limited. In the present embodiment, as an example, the configuration setting support system is distributed to the analysis server 11, the analysis information collection server 14, the client 16, and the storage system 18 and a part thereof coexists with the storage system 18. The analysis server 11, the analysis information collection server 14, the client 16, and the storage system 18 are communicably connected via a network 22. The network 22 is configured as a communication network such as a LAN (Local Area Network) and/or a WAN (Wide Area Network), which enables cable and/or wireless communication.

The storage system 18 is an information processing system that stores data. The storage system 18 includes a storage management server 19 and a plurality of storages 21. The storage 21 is a storage apparatus in which a logical configuration defined in configuration information is constructed.

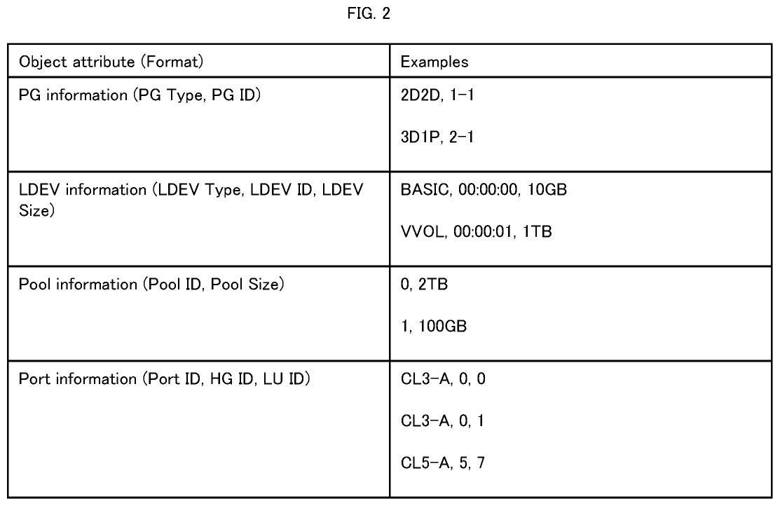

FIG. 2 is a diagram illustrating an example of configuration information. Information related to objects of each attribute of a logical configuration of the storage 21 is recorded in the configuration information in correlation with an apparatus ID of the storage 21 and an acquisition time point. In the present embodiment, PG, LDEV, Pool, and Port are used as the object attribute.

The PG is a parity group (that is, a RAID group). Information on the PG includes a PG Type and a PG ID. The PG Type indicates a RAID type of the RAID group. A PG Type of 2D2D indicates a RAID type in which two pieces of data are prepared for two types of data. 3D1P indicates a RAID type in which one parity is prepared for three pieces of data. The PG ID is an identifier for identifying the RAID group.

The LDEV is a logical device. Information on the LDEV includes an LDEV Type, an LDEV ID, and an LDEV Size. The LDEV Type indicates the type of the LDEV. An LDEV Type of BASIC indicates an internal volume. VVOL indicates a virtual volume. The LDEV ID is an identifier for identifying the LDEV. The LDEV Size indicates the size of the LDEV.

The Pool is a pool having a storage capacity. The information on the Pool includes a Pool ID and a Pool Size. The Pool ID is an identifier for identifying the Pool. The Pool Size is the size of the storage capacity of the Pool.

The Port is a port. The information on the Port includes a Port ID, a HG ID, and a LU ID.

The Port ID is an identifier for identifying the Port. The HG ID is an identifier of a host group of the Port. The LU ID is an identifier of a logical unit of the Port.

The storage management server 19 is a server that manages the plurality of storages 21 and includes an information acquirer 20. The information acquirer 20 acquires information including the configuration information and the operation log of each storage 21 by communicating with a GUM (Gateway for United Management) (not illustrated) that provides a management function for managing the storages 21.

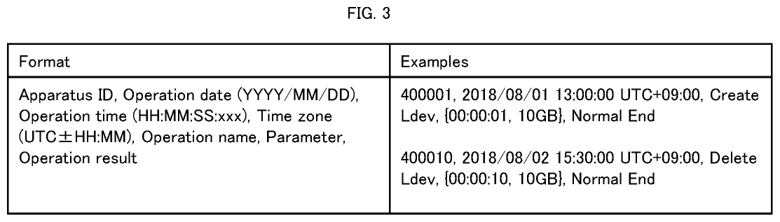

FIG. 3 is a diagram illustrating an example of the operation log. The operation log is history information related to operations executed for the storage 21. In the present embodiment, the operation log has a format including “apparatus ID, operation date (YYYY/MM/DD), operation time (HH:MM:SS:xxx), time zone (UTC±HH:MM), operation name, parameter, and operation result”. The apparatus ID is an identifier of the storage 21 on which an operation was executed. The operation date is the date when an operation was executed. The operation time is a time point at which an operation was executed. The time zone is a time zone of the operation date and the operation time. The operation name is the name of an executed operation. An operation name of Create Ldev indicates an operation of generating an LDEV. Delete Ldev indicates an operation of deleting an LDEV. The parameter is a parameter used for the operation. The operation result is the execution result of the operation. An operation result of Normal End indicates a normal end of the operation.

The storages 21 may include a storage apparatus serving as a target in which configuration information is set with the support of the configuration setting support system as well as a storage apparatus which is under control of the configuration setting support system and of which the configuration information or the like can be acquired by the configuration setting support system. The target storage apparatus has basically the same configuration as the storage 21 under control.

The analysis information collection server 14 is a server that collects configuration information of the storages 21 from the storage management server 19 of each storage system 18 and includes an information merger 15. The information merger 15 collects the configuration information of each storage 21 acquired by the information acquirer 20 of the storage management server 19 of each storage system 18, extracts information used for constructing a logical configuration of the storage apparatus, merges the extracted pieces of information to generate analysis data, and provides the same to the analysis server 11. The analysis data in the present embodiment includes information on predetermined minimum objects necessary for the logical configuration of the storage apparatus and information on the time point at which the information was acquired. Processing of merging the extracted pieces of information to generate the analysis data is referred to as merging processing, and the details thereof will be described later.

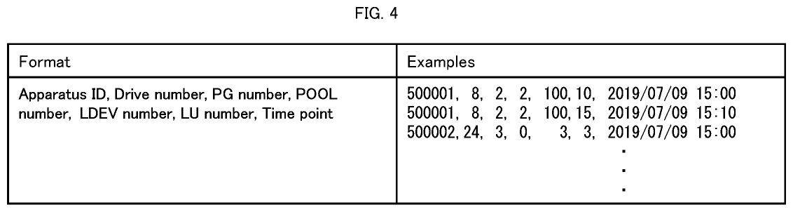

FIG. 4 is a diagram illustrating an example of the analysis data. The schema of the analysis data includes an apparatus ID of the storage apparatus, a Drive number, a PG number, a POOL number, an LDEV number, an LU number, and a time point. The Drive number is the number of drives. The PG number is the number of PGs. The POOL number is the number of Pools. The LDEV number is the number of LDEVs. The LU number is the number of LUs.

When an operation related to an object included in the schema is performed, the information on the object may change. Therefore, for example, the analysis information collection server 14 may add a new record to the analysis data on the basis of the configuration information when an operation related to the object included in the schema was performed by referring to the operation log.

The analysis server 11 selects one or more storages 21 serving as recommended candidates on the basis of the analysis data provided from the analysis information collection server 14 and generates a script for setting the configuration information in a target storage apparatus on the basis of the configuration information of the recommended candidates. The analysis server 11 includes a candidate extractor 12 and a script generator 13.

The candidate extractor 12 selects recommended candidates among the storages 21 under control. For example, a storage 21 in which the configuration information close to a predetermined desired configuration is set may be selected as the recommended candidate preferentially. Moreover, for example, a priority may be assigned in advance to an attribute of the object that constitutes the logical configuration, and the recommended candidate may be selected by taking the priority into consideration. Moreover, the recommended candidate may be selected from the storages 21 having the configuration information having a record value in a predetermined number or more of storages 21 under control. The processing of selecting the recommended candidate is referred to as recommended candidate selection processing and the details thereof will be described later.

The script generator 13 creates a script for setting configuration information in a target storage apparatus in which configuration information is set on the basis of the configuration information of the recommended candidate storages 21. The script is a file including a series of commands for realizing a configuration indicated by the configuration information of the recommended candidate in the target storage apparatus. For example, when a new target storage apparatus is constructed, a script for performing initial setting according to the configuration information may be created. Moreover, when the target storage apparatus is an existing apparatus, a script for updating the setting of the present configuration applied to the target storage apparatus according to the configuration information of the recommended candidate may be created. The process of creating the script is referred to as script creation processing, and the details thereof will be described later.

The client 16 is an apparatus that provides a user interface of the configuration setting support system and includes a configuration reader 17, and the configuration reader 17 operates the configuration setting support system according to an operation of a user 23. Moreover, the client 16 provides an operation result of the configuration setting support system to the user 23 by displaying the same on a screen and/or outputting the same as a file.

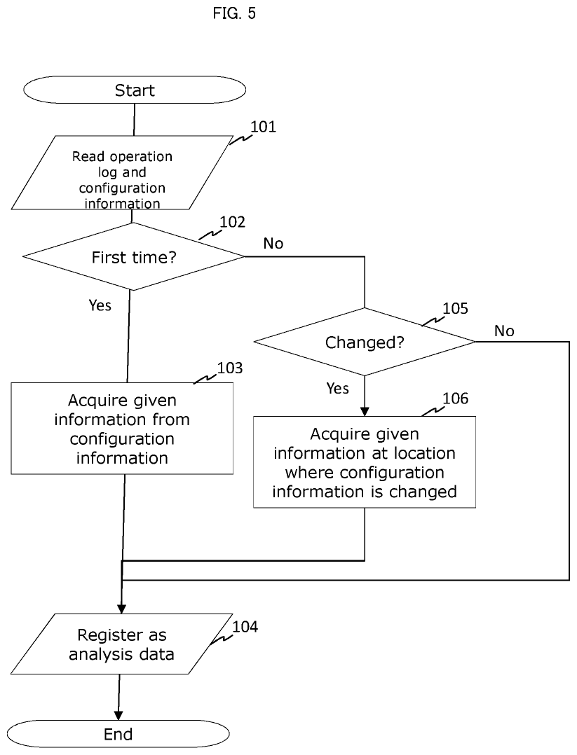

FIG. 5 is a flowchart of merging processing.

The information merger 15 collects the operation log and the configuration information from each storage management server 19 (step 101). Subsequently, the information merger 15 determines whether this is the first registration of analysis data (step 102). If this is the first registration, the information merger 15 extracts given information used for constructing the logical configuration of the storage apparatus from the configuration information (step 103). In the present embodiment, from the information explicitly or implicitly illustrated in the configuration information of FIG. 2, an apparatus ID, a Drive number, a PG number, a POOL number, an LDEV number, an LU number, and a time point serving as the records of the analysis data illustrated in FIG. 4 are acquired. Subsequently, the information merger 15 registers the information acquired from the configuration information as analysis data (step 104).

When this is not the first registration in step 102, the information merger 15 determines whether the value of an attribute to be recorded as analysis data, in the configuration information is changed (step 105). If the attribute value is not changed, the information merger 15 registers information up to the latest records acquired in the past as the analysis data (step 104). If the attribute value is changed in step 105, the information merger 15 identifies a location where the configuration information is changed on the basis of the operation log, acquires given information used for constructing the logical configuration of the storage apparatus from the location, and adds the same as a new record after the latest records acquired in the past (step 106). Subsequently, the information merger 15 registers information up to the newly added record as the analysis data (step 104).

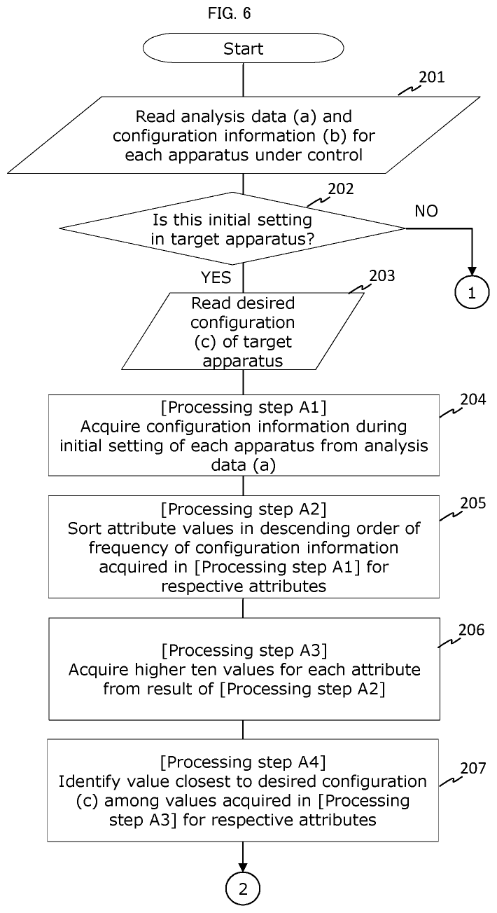

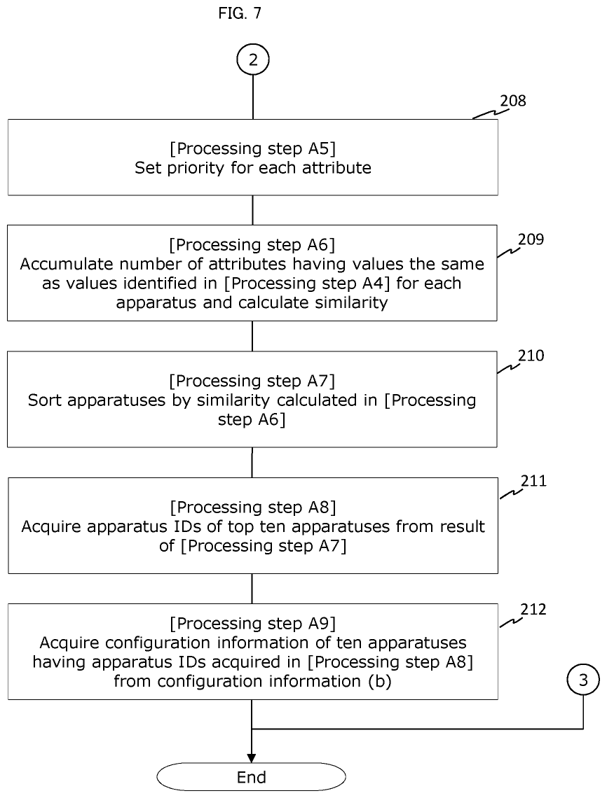

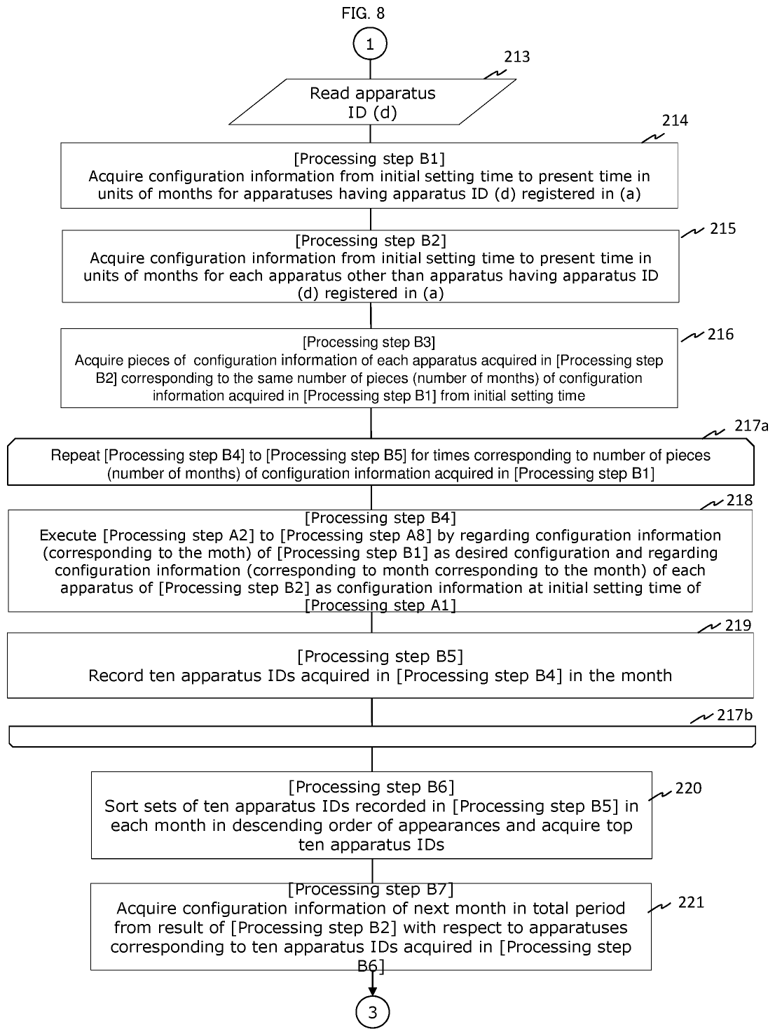

FIGS. 6 to 8 are flowcharts of the recommended candidate selection process.

First, the candidate extractor 12 reads analysis data (hereinafter referred to (a)) and configuration information (hereinafter referred to as (b)) for each storage 21 which is an apparatus under control (step 201). Subsequently, the candidate extractor 12 determines whether this is the first setting (initial setting) of the configuration information in the storage which is the target apparatus (step 202).

If this is the first setting, the candidate extractor 12 reads the configuration information (hereinafter referred to as (c)) of the target apparatus (step 203) and executes processing steps A1 to A9 (steps 204 to 212). The content of processing steps A1 to A9 will be described later. On the other hand, if this is not the first setting, the candidate extractor 12 reads an apparatus ID (hereinafter referred to as (d)) of the target apparatus (step 213) and executes processing steps B1 to B7 (steps 214 to 221).

Hereinafter, processing steps A1 to A9 will be described.

In processing step A1, the candidate extractor 12 acquires the configuration information during the initial setting of each apparatus under control from the analysis data (a) (step 204) and proceeds to processing step A2.

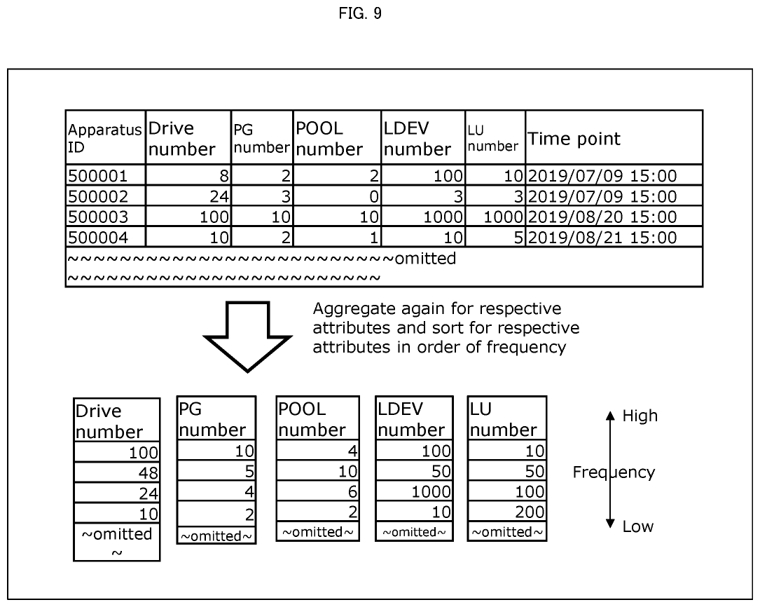

FIG. 9 is a conceptual diagram for describing processing step A2. As illustrated in FIG. 9, in processing step A2, the candidate extractor 12 aggregates attribute values for each apparatus, which are the result of processing step A1 for respective attributes again and sorts the attribute values in descending order of frequencies. The frequency of values indicates how many apparatuses are using the value (step 205).

In processing step A3, the candidate extractor 12 acquires a predetermined number of (for example top ten) values having the higher frequencies for the attribute of each object from the result of processing step A2 (step 206). An attribute value having a higher frequency means that the use record in the apparatus under control is high. By using a predetermined number or smaller of values having the higher frequencies, it is possible to use values having a use record to some extent.

In processing step A4, the candidate extractor 12 identifies a value closest to the value of the desired configuration for each attribute from the result of processing step A3 (step 207).

In processing step A5, the candidate extractor 12 sets a priority to each attribute (step 208). This priority determines which attribute value of an object will be preferentially used for constructing the configuration information. In the present embodiment, an attribute located closer to the root side (the lower layer side) in the dependency of the objects of a storage is prioritized. Specifically, the priority increases in order of Drive number, PG number, POOL number, LDEV number, and LU number.

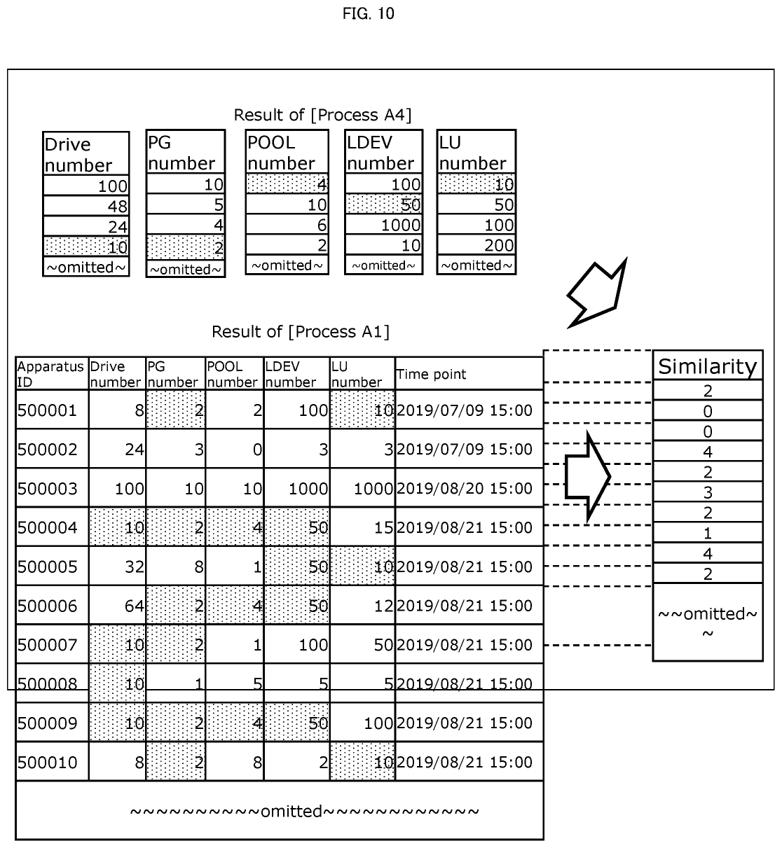

FIG. 10 is a conceptual diagram for describing processing step A6. As illustrated in FIG. 10, in processing step A6, the candidate extractor 12 calculates a similarity between the configuration information and the desired configuration for each apparatus under control by accumulating the number of attributes having values the same as or closest to the values identified in processing step A4 for each apparatus under control (step 209). In FIG. 10, since the values of attributes having values the same as or closest to the values identified in processing step A4 are shaded, the number of shaded portions may be counted for each apparatus under control.

In processing step A7, the candidate extractor 12 sorts the apparatuses under control in descending order of the similarities calculated in processing step A6 (step 210). If attributes have the same similarity, an attribute (the shaded attribute in FIG. 10) having a value the same as or closest to the value identified in processing step A4 among attributes having higher priorities is on the higher rank.

In processing step A8, the candidate extractor 12 acquires the apparatus IDs of a predetermined number of (in the present embodiment, ten as an example) higher-rank apparatuses from the result of processing step A7 (step 211). The apparatuses of which the apparatus IDs are acquired herein are the recommended candidates.

In processing step A9, the candidate extractor 12 extracts the configuration information of each of the ten apparatuses having the apparatus IDs acquired in processing step A8 from the configuration information (b) acquired in step 202 (step 212).

Hereinafter, processing steps B1 to B7 will be described.

In processing step B1, the candidate extractor 12 acquires the configuration information of all periods from the initial setting time to the present time in units of months for the apparatuses having the apparatus ID (d) registered in the analysis data (a), that is, target apparatuses (step 214).

In processing step B2, the candidate extractor 12 acquires the configuration information from the initial setting time to the present time in units of months for each apparatus other than the apparatus having the apparatus ID (d) registered in the analysis data (a) among the apparatus under control (step 215).

In processing step B3, the candidate extractor 12 extracts a number of pieces of configuration information corresponding to the same number of pieces (number of months) as that of the configuration information acquired in processing step B1 from the initial setting time from the pieces of configuration information of each apparatus acquired in processing step B2 (step 216). A period corresponding to the number of months extracted herein from the initial setting time is referred to as a total period.

Furthermore, the candidate extractor 12 executes processing steps B4 and B5 illustrated below with respect to each month of configuration information corresponding to the number of pieces (number of months) of the configuration information acquired in processing step B1 (steps 217a to 217b).

In processing step B4, the candidate extractor 12 executes processing steps A2 to A8 by regarding the configuration information of the target apparatus in the month acquired in processing step B1 as the configuration information (c) of processing step A1 and regarding the configuration information of a month corresponding to the month as counted from the initial setting time of each apparatus acquired in processing step B2 as the configuration information at the initial setting time of processing step A1 (step 218).

In processing step B5, the candidate extractor 12 records a predetermined number of (in the present embodiment, ten as an example) apparatus IDs acquired in processing step B4 for the month (step 219).

In processing step B6, the candidate extractor 12 sorts sets of ten apparatus IDs recorded in processing step B6 in the total period up to a month corresponding to the present month, of the target apparatus from the initial setting time in descending order of appearances and acquires a predetermined number of (in the present embodiment, ten as an example) higher apparatus IDs (step 220). The apparatuses of which the apparatus IDs are acquired herein are the recommended candidates.

In processing step B7, the candidate extractor 12 acquires the configuration information of the next month in the total period from the result of processing step B2 with respect to the apparatuses corresponding to the ten apparatus IDs acquired in processing step B6 (step 221).

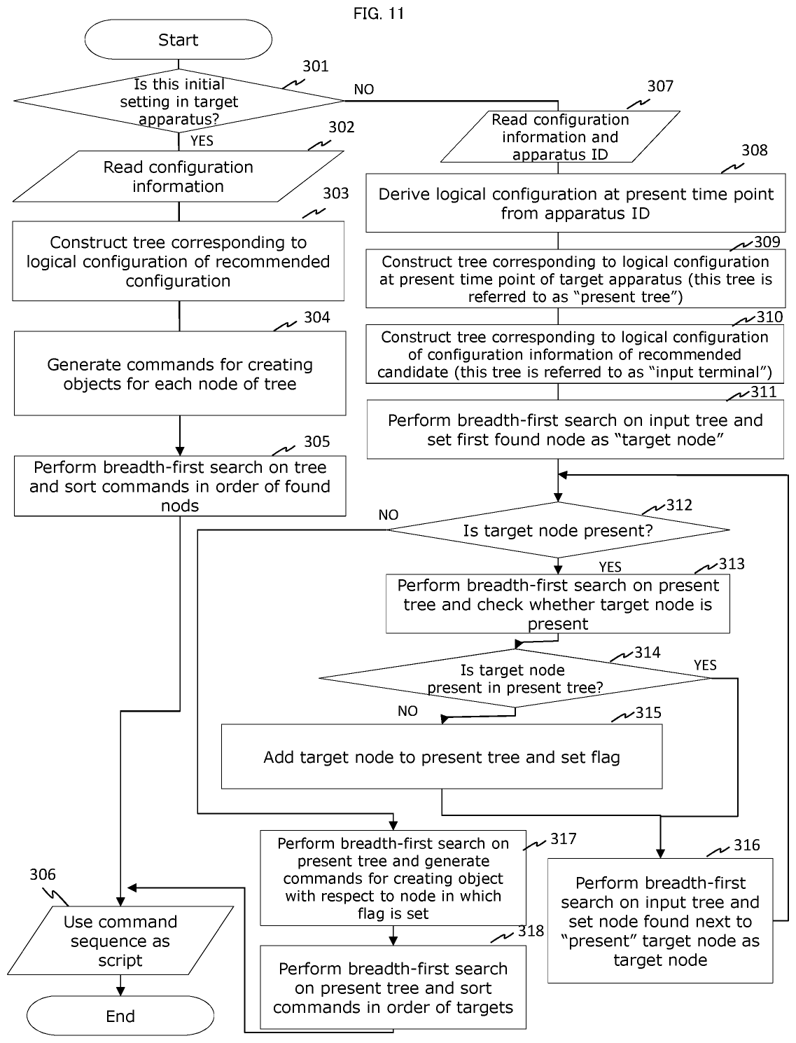

FIG. 11 is a flowchart of the script creation process.

The script generator 13 determines whether this is the first setting (initial setting) of the configuration information in the storage which is a target apparatus (step 301).

If this is the first setting, the script generator 13 reads the configuration information of the storage 21 which is a recommended candidate (step 302). As a logical configuration, the configuration information includes dependency that objects of the storage 21 which is a recommended candidate have a plurality of layers. The script generator 13 constructs a tree corresponding to the logical configuration of the read configuration information (step 303). That is, a tree of objects in which a lower layer of the logical configuration is closer to the root side is constructed. For example, a tree is constructed in such a way that the system is a root and nodes arranged in the order of Drive, PG, POOL, LDEV, and LU are connected from the root until reaching leaves. Subsequently, the script generator 13 generates commands for creating objects corresponding to the nods of the constructed tree (step 304). Furthermore, the script generator 13 performs breadth-first search on the tree and sorts the commands corresponding to the nodes in order of nodes found in the search (step 305). The script generator 13 uses the sorted command sequence as a script (step 306).

If this is not the first setting in step 301, the script generator 13 reads the configuration information of the storage 21 which is a recommended candidate and the apparatus ID of the storage 21 which is a target apparatus (step 307). Subsequently, the script generator 13 derives the logical configuration of the configuration information of the storage 21 which is the target apparatus from the apparatus ID (step 308). Subsequently, the script generator 13 constructs a tree corresponding to the logical configuration of the target apparatus, that is, a tree of objects in which the lower layer of the logical configuration is on the root side (step 309). Hereinafter, this tree is referred to as a “present tree”. Subsequently, the script generator 13 constructs a tree corresponding to the logical configuration of the configuration information of the recommended candidate, that is, a tree of objects in which the lower layer of the logical configuration is on the root side (step 310). Hereinafter, this tree is referred to as an “input tree”.

Subsequently, the script generator 13 performs breadth-first search on the input tree and sets the first found node as the target of the following processing (step 311). Hereinafter, this node is referred to as a target node.

Subsequently, the script generator 13 determines whether a target node is present in the input tree (step 312). If the target node is present in the input tree, the script generator 13 performs breadth-first search on the present tree to check whether a node corresponding to the target node in the input tree is present in the present tree (step 313) and determines whether a node corresponding to the target node is present in the present tree (step 314).

If a node corresponding to the target node is not present in the present tree, the script generator 13 adds a node corresponding to the target node to the present tree and sets a flag to the node indicating that the node is newly added (step 315). In this case, the position in the present tree to which the new node is added is the same position of the same layer as the layer on which the target node is present in the input tree.

When the node corresponding to the target node is present in the present tree in step 314 or after step 315 is executed, the script generator 13 performs breadth-first search on the input tree and sets a node found next to the present target node as a new target node (step 316) and returns to step 312.

If the target node is not present in the input tree in step 312, the script generator 13 performs breadth-first search on the present tree, and when a node in which a flag is set is found, generates commands for creating an object corresponding to the node (step 317). Subsequently, the script generator 13 performs breadth-first search on the present tree and sorts commands corresponding to the node in which a flag is set in order of nodes found in the search (step 318). The script generator 13 uses the sorted command sequence as a script (step 306).

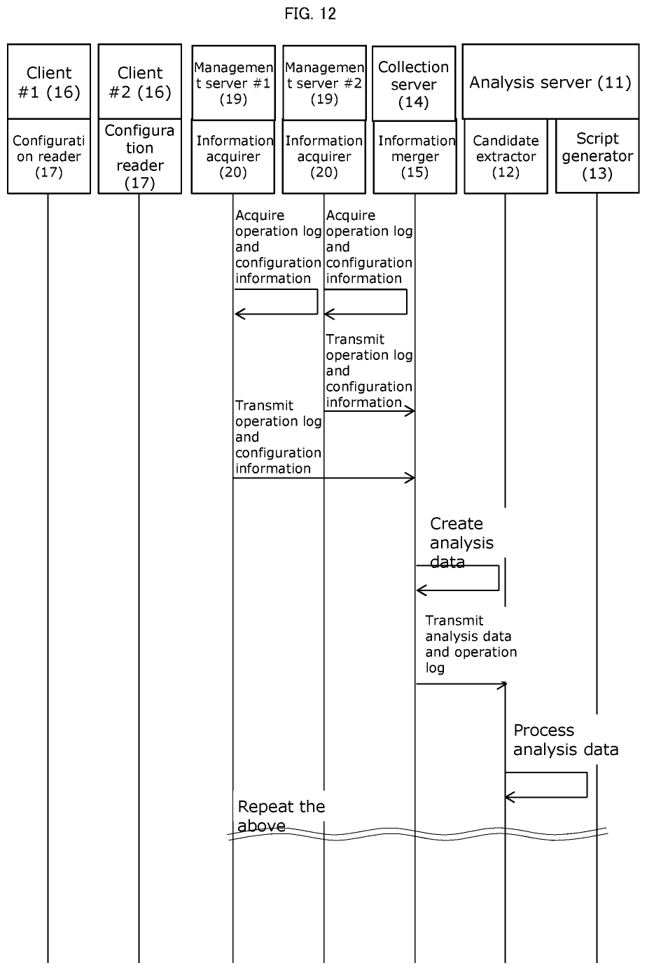

FIG. 12 is a sequence diagram between apparatuses associated with the merging process.

In this example, as a configuration example, it is assumed that two storage systems 18 are provided, and each includes the storage management server 19. Moreover, it is assumed that two clients 16 are provided.

First, the information acquirers 20 of the storage management servers #1 and #2 (19) acquire the operation log and the configuration information of the storages 21 under control thereof and transmit the same to the information merger 15 of the analysis information collection server 14. The information merger 15 merges the configuration information received from the information acquirers 20 to create analysis data and transmits the analysis data and the operation log to the candidate extractor 12 of the analysis server 11. The candidate extractor 12 processes the received analysis data.

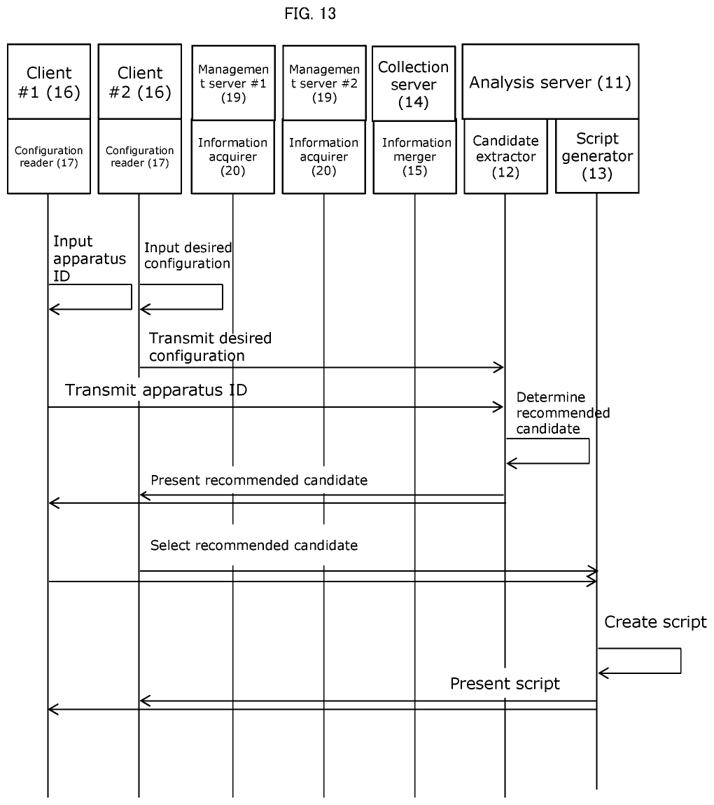

FIG. 13 is a sequence diagram between apparatuses associated with the recommended candidate selection process and the script creation process.

In this example, similarly to the configuration example of FIG. 12, it is assumed that two storage systems 18 are provided and each includes the storage management server 19. Moreover, it is assumed that two clients 16 are provided. In this example, it is assumed that the user of the client #1 (16) wants to augment the storage in operation (apparatus augmentation). It is assumed that the user of the client #2 (16) wants to perform initial setting of the configuration information in a new storage.

First, the configuration reader 17 of the client #1 (16) receives an apparatus ID of a storage which is a target apparatus in which configuration information is to be set, the apparatus ID being input by the user. Moreover, the configuration reader 17 of the client #2 (16) receives a desired configuration which is a configuration desired by the user as an initial setting in the target apparatus, the desired configuration being input by the user. The configuration reader 17 of the client #1 (16) transmits the received apparatus ID to the candidate extractor 12 of the analysis server 11. The configuration reader 17 of the client #2 (16) transmits the received desired configuration to the candidate extractor 12 of the analysis server 11.

The candidate extractor 12 determines the storage 21 which uses the configuration information close to the desired configuration from the client #2 at the initial setting time as the recommended candidate using the analysis data and the operation log acquired in the sequence illustrated in FIG. 12. A plurality of recommended candidates may be determined. The candidate extractor 12 presents the determined recommended candidate to the configuration reader 17 of the client #2 (16).

The candidate extractor 12 determines the storage 21 having the progress of update of the configuration information close to the progress of update so far of the configuration information of the target apparatus indicated by the apparatus ID from the client #1 as the recommended candidate using the analysis data and the operation log acquired in the sequence illustrated in FIG. 12. A plurality of recommended candidates may be determined. The candidate extractor 12 presents the determined recommended candidate to the configuration reader 17 of the client #1 (16).

The configuration reader 17 of each of the clients #1, #2 (16) selects one of the recommended candidates presented from the candidate extractor 12 according to the user's operation and notifies the script generator 13 of the analysis server 11 of the selected recommended candidate. The script generator 13 creates a script for setting the configuration information in the target apparatus on the basis of the configuration information of the selected recommended candidate and presents the same to the configuration readers 17 of the clients #1, #2 (16). The script for the initial setting is a script for setting desired configuration information newly. A script for configuration augmentation is a script for updating the present configuration information with desired configuration information.

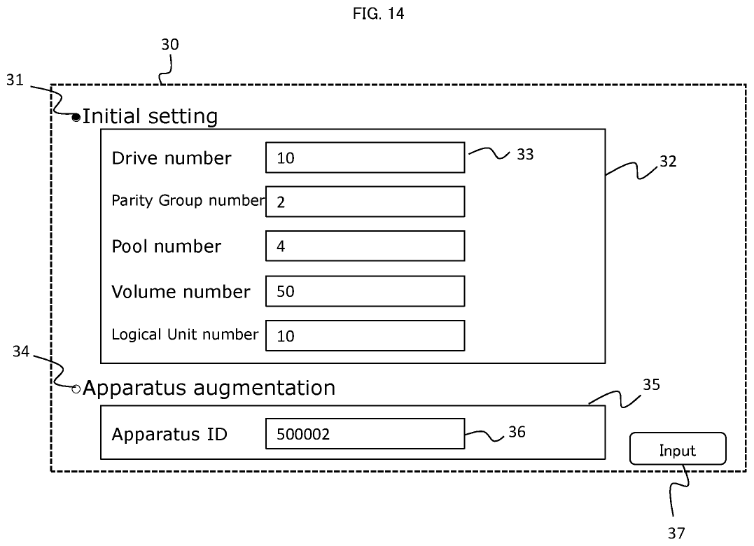

FIG. 14 is a diagram illustrating an input screen for receiving the user's input of a script creation instruction.

An input screen 30 includes radio buttons 31 and 34 for selecting initial setting or apparatus augmentation, input areas 32 and 35 for initial setting and apparatus augmentation, and an input button 37 for confirming the input content and issuing a script creation instruction. The user can select whether initial setting or apparatus augmentation will be performed using the radio buttons 31 and 34. When the radio button 31 for initial setting is pressed, the input area 32 for initial setting is activated and a state in which text can be input in a text box 33 is created. In this case, the input area 35 for apparatus augmentation is deactivated and a state in which text cannot be input in a text box 36 is created. When the input button 37 is pressed, creation of a script with the input content set in the activated input area starts.

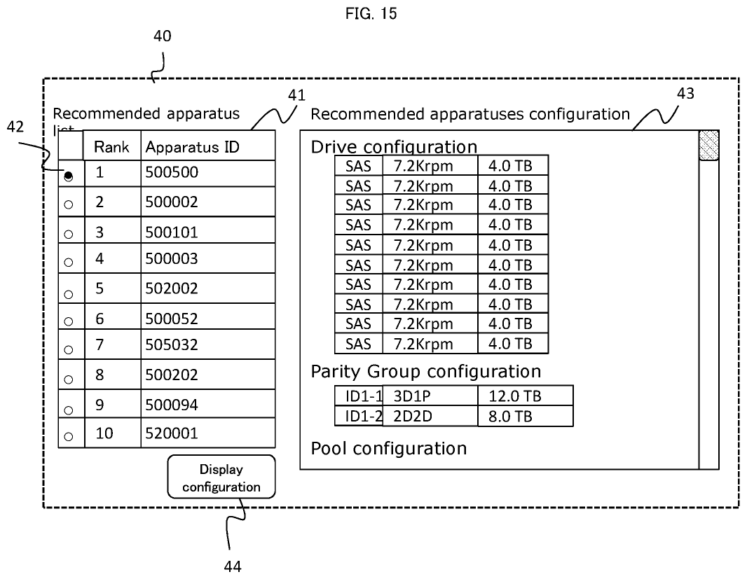

FIG. 15 is a diagram illustrating an output screen for presenting a recommended candidate to a user.

An output screen 40 includes an output area 41 for displaying a list of recommended candidates, an output area 43 for displaying an apparatus configuration of the recommended candidate, and a configuration display button 44. The output area 41 includes a list of apparatus IDs of storages which are recommended candidates and a radio button 42 correlated with each apparatus ID. When the radio button 42 corresponding to one of apparatus IDs is pressed, a state in which a storage having the apparatus ID is selected is created. When the configuration display button 44 is pressed in a state where a certain storage is selected, an apparatus configuration of the selected storage is displayed in the output area 43. Objects on each layer of the storage and information on the objects are displayed in the output area 43.

The present embodiment described hereinabove includes the following items. However, the items included in the present embodiment are not limited to the following.

Item 1

A configuration setting support system is a configuration setting support system that supports setting of configuration information in an information processing apparatus, the configuration setting support system including: an information acquirer configured to acquire configuration information set in a plurality of information processing apparatuses under management; and a candidate extractor configured to select at least one of the plurality of information processing apparatuses under management on the basis of a configuration of a target information processing apparatus and the configuration information of the plurality of information processing apparatuses under management and uses the selected at least one information processing apparatus under management as a recommended candidate recommended to be used for creating the configuration information of the target information processing apparatus. In this way, since the recommended candidate is selected from the information processing apparatuses under management, it is possible to support setting of configuration information in the target information processing apparatus on the basis of the configuration information having records.

Item 2

The configuration setting support system according to Item 1 further includes a user interface unit configured to receive an input for designating the target information processing apparatus. In this way, since a designation of the target information processing apparatus is received and the recommended candidate for the designated target information processing apparatus is determined, it is possible to support setting of suitable configuration information in a desired target information processing apparatus.

Item 3

In the configuration setting support system according to Item 2, the user interface unit is configured to receive an input of a desired configuration that is desirable to be set in the target information processing apparatus, and the candidate extractor is configured to select at least one of the plurality of information processing apparatuses under management on the basis of the desired configuration and the configuration information of the information processing apparatuses under management. In this way, since the desired configuration is received and the recommended candidate is selected according to the desired configuration, it is possible to support setting of desired configuration information in the target information processing apparatus.

Item 4

The configuration setting support system according to Item 1 further includes a support information creator configured to create support information for setting configuration information in the target information processing apparatus on the basis of configuration information of the recommended candidate information processing apparatus under management. In this way, since the support information based on the configuration of the recommended candidate is generated, it is possible to facilitate setting of configuration information in the target information processing apparatus.

Item 5

In the configuration setting support system according to Item 4, the support information creator is configured to create support information for updating the configuration information of the target information processing apparatus with the configuration information of the recommended candidate information processing apparatus under management on the basis of a difference between existing configuration information set in the target information processing apparatus and the configuration information of the recommended candidate information processing apparatus under management. In this way, since the support information for updating the configuration information is generated on the basis of a difference between the existing configuration information of the target information processing apparatus and the configuration information of the recommended candidate information processing apparatus under management, it is possible to easily update the configuration information set in advance in the target information processing apparatus.

Item 6

In the configuration setting support system according to Item 3, the configuration information of the information processing apparatus under management includes a logical configuration made up of a plurality of attributes of objects, and the candidate extractor select at least one of the plurality of information processing apparatuses under management on the basis of the number of objects of each of the plurality of attributes in the desired configuration and the number of objects of each of the plurality of attributes in the configuration information of the information processing apparatuses under management. In this way, since the recommended candidate is selected on the basis of the priority of each object attribute, an information processing apparatus under management closer to the configuration information of the object having a high priority can be recommended as the recommended candidate.

Item 7

In the configuration setting support system according to Item 3, the configuration information of the information processing apparatuses under management includes a logical configuration made up of a plurality of attributes of objects, a priority is set to each of the attributes, and the candidate extractor is configured to select at least one of the plurality of information processing apparatuses under management on the basis of the desired configuration, the configuration information of the information processing apparatuses under management, and the priority. In this way, since the recommended candidate is selected on the basis of the priority of each object attribute, the information processing apparatus under management closer to the configuration information of the object having a high priority can be recommended as the recommended candidate.

Item 8

In the configuration setting support system according to Item 7, the configuration information of the information processing apparatuses under management includes a logical configuration made up of a plurality of layers of objects, and the layers are the attributes. In this way, since the recommended candidate is selected on the basis of the priority of each object layer, the information processing apparatus under management closer to the configuration information of the object layer having a high priority can be recommended as the recommended candidate.

Item 9

In the configuration setting support system according to Item 2, the candidate extractor is configured to select at least one of the plurality of information processing apparatuses under management as the recommended candidate on the basis of change in the configuration information from initial setting of the target information processing apparatus and change in the configuration information from initial setting of the information processing apparatuses under management. In this way, since the information processing apparatus under management in which change in configuration information is close to change up to the present time point of the configuration information of the target information processing apparatus is recommended as the recommended candidate, it is possible to support setting of configuration information in the information processing apparatus in operation by taking changes into consideration.

Item 10

The configuration setting support system according to Item 9 further includes a support information creator configured to create support information for setting the configuration information in the target information processing apparatus on the basis of configuration information at a next time point of configuration information of the information processing apparatus under management selected as the recommended candidate, corresponding to the configuration information at a present time point of the target information processing apparatus. In this way, since support information is generated using the configuration information of the information processing apparatus under management in which change in configuration information is close to change up to the present time point of the configuration information of the target information processing apparatus, it is possible to facilitate setting of configuration information in the information processing apparatus in operation.

The above-described embodiment is an example for describing the present disclosure and the present disclosure is not limited by the embodiment. The present invention can be embodied in a variety of other aspects by those skilled in the art without departing from the scope of the present disclosure.

What is claimed is:

1. A configuration setting support system that supports setting of configuration information in an information processing apparatus, the configuration setting support system comprising:
an information acquirer configured to acquire configuration information set in a plurality of information processing apparatuses under management; and
a candidate extractor configured to select at least one of the plurality of information processing apparatuses under management on a basis of a configuration of a target information processing apparatus and the configuration information of the plurality of information processing apparatuses under management and uses the selected at least one information processing apparatus under management as a recommended candidate recommended to be used for creating the configuration information of the target information processing apparatus.

2. The configuration setting support system according to claim 1, further comprising
a user interface unit configured to receive an input for designating the target information processing apparatus.

3. The configuration setting support system according to claim 2, wherein
the user interface unit is configured to receive an input of a desired configuration that is desirable to be set in the target information processing apparatus, and
the candidate extractor is configured to select at least one of the plurality of information processing apparatuses under management on a basis of the desired configuration and the configuration information of the information processing apparatuses under management.

4. The configuration setting support system according to claim 1, further comprising
a support information creator configured to create support information for setting configuration information in the target information processing apparatus on a basis of configuration information of the recommended candidate information processing apparatus under management.

5. The configuration setting support system according to claim 4, wherein
the support information creator is configured to create support information for updating the configuration information of the target information processing apparatus with the configuration information of the recommended candidate information processing apparatus under management on a basis of a difference between existing configuration information set in the target information processing apparatus and the configuration information of the recommended candidate information processing apparatus under management.

6. The configuration setting support system according to claim 3, wherein
the configuration information of the information processing apparatuses under management includes a logical configuration made up of a plurality of attributes of objects, and
the candidate extractor is configured to select at least one of the plurality of information processing apparatuses under management on a basis of a number of objects of each of the plurality of attributes in the desired configuration and a number of objects of each of the plurality of attributes in the configuration information of the information processing apparatuses under management.

7. The configuration setting support system according to claim 3, wherein
the configuration information of the information processing apparatuses under management includes a logical configuration made up of a plurality of attributes of objects,
a priority is set to each of the attributes, and
the candidate extractor is configured to select at least one of the plurality of information processing apparatuses under management on a basis of the desired configuration, the configuration information of the information processing apparatuses under management, and the priority.

8. The configuration setting support system according to claim 7, wherein
the configuration information of the information processing apparatuses under management includes a logical configuration made up of a plurality of layers of objects, and
the layers are the attributes.

9. The configuration setting support system according to claim 2, wherein
the candidate extractor is configured to select at least one of the plurality of information processing apparatuses under management as the recommended candidate on a basis of change in the configuration information from initial setting of the target information processing apparatus and change in the configuration information from initial setting of the information processing apparatuses under management.

10. The configuration setting support system according to claim 9, further comprising
a support information creator configured to create support information for setting the configuration information in the target information processing apparatus on a basis of configuration information at a next time point of configuration information of the information processing apparatus under management selected as the recommended candidate, corresponding to the configuration information at a present time point of the target information processing apparatus.

11. A configuration setting support method for supporting setting of configuration information in an information processing apparatus, the configuration setting support method comprising causing a computer to execute:
acquiring configuration information set in a plurality of information processing apparatuses under management; and
selecting at least one of the plurality of information processing apparatuses under management on a basis of a configuration of a target information processing apparatus and the configuration information of the plurality of information processing apparatuses under management and using the selected at least one information processing apparatus under management as a recommended candidate recommended to be used for creating the configuration information of the target information processing apparatus.
